(19) United States
(12) Patent Application Publication
(10) Pub. No.: US 2006/0247869 A1
(43) Pub. Date: Nov. 2, 2006

(54) Multiphase flow meter and data system

(76) Inventor: Guillermo Amarfil Lucero, Buenos Aires (AR)

Correspondence Address: LITMAN LAW OFFICES, LTD, PO BOX 15035, CRYSTAL CITY STATION, ARLINGTON, VA, 22215, US

(21) Appl. No.: 11/402,768

(22) Filed: Apr. 13, 2006

Related U.S. Application Data
(60) Provisional application No. 60/674,682, filed on Apr. 26, 2005.

(51) Int. Cl. G06F 19/00

(52) U.S. Cl. 702/50

(57) ABSTRACT

A multiphase flow meter and data system including a volumetric flow meter, a water percentage meter, a multiphase density sensor, and a data center interconnected to the volumetric flow meter, the water percentage meter, and the multiphase density sensor. The multiphase density sensor has piping with a first transition section, a non-conductive section, and a second transition section. Two conductive plates are externally mounted to the non-conductive section, thereby forming a capacitor. The multiphase flow meter and data system provides a way to measure the percentages of water, gas, and/or crude oil that flow in a pipeline without the separation of phases on-line and in real time. The multiphase flow meter and data system allows reliable real-time measurement with the possibility to transmit results to a remote location without the presence of a technician at the measuring site.

### CROSS-REFERENCE TO RELATED APPLICATION

This application claims the benefit of U.S. Provisional Patent Application Ser. No. 60/674,682, filed Apr. 26, 2005.

### BACKGROUND OF THE INVENTION

1. Field of the Invention

The present invention generally relates to flow meters and, more particularly, to a multiphase flow meter and data system.

2. Description of the Related Art

Multiple oil and/or gas wells are usually connected to an oil and/or gas battery with an oil and/or gas gathering system pipeline. A typical oil and/or gas battery has multiple oil and/or gas wells in production; e.g., approximately twenty to thirty. Oil, gas, and/or water can simultaneously flow into the wells from a single producing formation. This multiphase flow of oil, gas, and/or water results in a production mixture that can be separated into its respective components. Since commercial markets normally exist for only oil and gas, the production mixture is typically separated into its respective components.

The operator of the wells normally leases out the wells and needs to acquire well test data before the operator can properly manage the lease. Well test data includes wellhead pressure data, as well as the volumetric flow rates for the respective oil, gas, and/or water components of a production mixture that originates from a single well. The well test information is used to determine the revenue derived from each producing well among the various ownership interests in that well.

The net amount of oil, gas, and/or water that is produced from a particular well can be determined from the total volume flow rate of the flow stream for the particular well based on density measurements. Given the large quantities of crude oil and/or gas that are usually involved, any small inaccuracies in measuring density can disadvantageously accumulate over a relatively short interval of time to become a large error in a totalized volumetric measure.

Therefore, a need exists for a multiphase flow meter and data system that accurately determines a net amount of oil, gas, and/or water that is produced from a particular well. Thus, a multiphase flow meter and data system solving the aforementioned problems is desired.

### SUMMARY OF THE INVENTION

The present invention is a multiphase flow meter and data system. The multiphase flow meter and data system has a volumetric flow meter, a water percentage meter, a multiphase density sensor, and a data center interconnected to the volumetric flow meter, the water percentage meter, and the multiphase density sensor. The multiphase density sensor has piping with a first transition section, a non-conductive section, and a second transition section. Two conductive plates are externally mounted to the non-conductive section, thereby forming a capacitor. The multiphase flow meter and data system provides a way to measure the percentages of water, gas, and/or crude oil that flow in a pipeline without the separation of phases on-line and in real time. The multiphase flow meter and data system allows reliable real-time measurement with the possibility to transmit results to a remote location without the presence of a technician at the measuring site.

These and other features of the present invention will become readily apparent upon further review of the following specification and drawings.

### BRIEF DESCRIPTION OF THE DRAWINGS

FIG. 1 is an environmental side view in section of a multiphase flow meter and data system according to the present invention, where the multiphase flow meter and data system is interconnected with an oil well pipe and a separator.

FIG. 2 is a side view in section of the multiphase flow meter and data system shown in FIG. 1.

FIG. 3 is a side view in section of the density sensor of the multiphase flow meter and data system shown in FIG. 1.

FIG. 4 is a block diagram of the data center of the multiphase flow meter and data system shown in FIG. 1.

Similar reference characters denote corresponding features consistently throughout the attached drawings.

### DETAILED DESCRIPTION OF THE PREFERRED EMBODIMENTS

The present invention is a multiphase flow meter and data system. Shown in the drawings, and described herein below in detail, are preferred embodiments of the invention. It is to be understood, however, that the present disclosure is an exemplification of the principles of the invention and does not limit the invention to the illustrated embodiments.

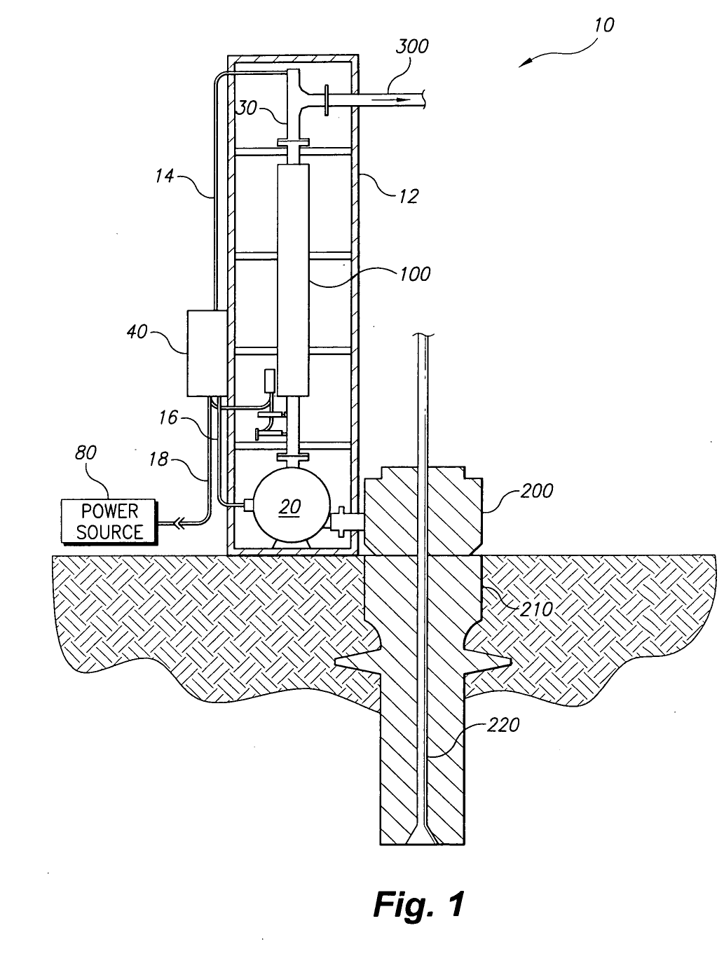

Referring to the drawings, FIG. 1 shows a multiphase flow meter and data system 10 according to the present invention, where the multiphase flow meter and data system 10 is interconnected to a well head 200 and a length of pipe 300. The well head 200 is connected to a well bore 210. A rotatable drill string 220 passes through the well head 200 and the well bore 200. A drill bit is mounted to the end of the drill string 220 in the well bore 200.

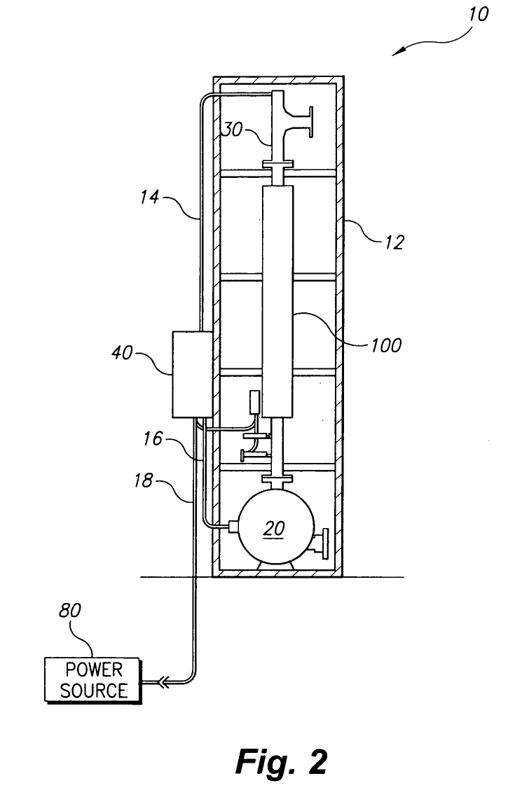

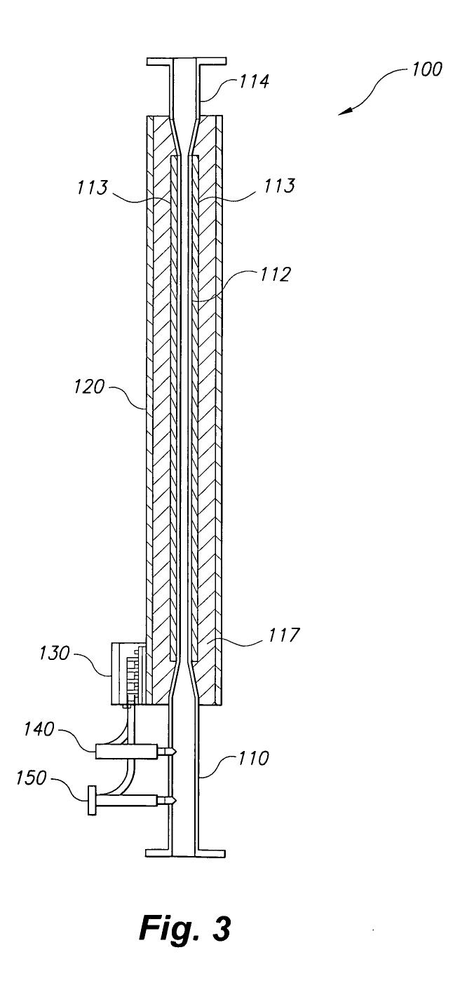

FIGS. 2-4 more particularly illustrate some components of the multiphase flow meter and data system 10. The multiphase flow meter and data system 10 has a housing 12. The housing 12 is made of durable and rigid material. Contained within the housing 12 are a volumetric flow meter 20, a water percentage meter 30 and a multiphase density sensor 100. These components are communicatively interconnected by wiring 14 and 16 to a data center 40 mounted on the outside of the housing 12. The data center 40 is connected to a power source 80 by wiring 18.

The volumetric flow meter 20 determines the volume per unit of time of the flow of the multiphase fluid passing through the multiphase flow meter and data system 10. As used herein, the term “multiphase fluid” is used to refer to a fluid, a mixture of fluid and gas, a mixture of liquid and gas, and/or a mixture of any type of fluid that may be in contact with other fluids, gases, liquids, etc. The volumetric flow meter 20 can be any suitable type of volumetric flow meter, such as, for example, a turbine meter, a vortex shedding flow meter, a fluidic, oscillating jet-type flow meter, a flow meter utilizing fluidic negative feedback oscillators, etc. The water percentage meter 30 determines the water content of the multiphase fluid passing through the multiphase flow meter and data system 10. The water percentage meter 30 can be any type of water percentage meter or water cut meter.

The multiphase density sensor 100 includes piping with a first transition section 110, a non-conductive section 112, and a second transition section 114. The first and second transition sections 110 and 114 each have flanges at their respective ends, and are formed of metal, such as stainless steel or the like. The non-conductive section 112 has a predetermined length and can be a rectangular or cylindrical pipe section formed of glass, plastic, ceramic, or the like. The thickness of the non-conductive section is preferably substantially constant along its length. Two conductive plates 113 are externally mounted to the non-conductive section 112, thereby forming a capacitor.

The capacitor has a dielectric determined by the thickness of the non-conductive section 112 and the characteristics of the multiphase flow passing through the non-conductive section 112. A protective pipe 120 covers the non-conductive section and portions of each transition section 112 and 114. The protective pipe 120 is formed of metal, such as stainless steel or the like. The protective pipe 120 acts as a Faraday cup to prevent electromagnetic interference. The space between the non-conductive pipe 112 and the protective pipe 120 can be filled with insulation resin 117. The ends of the density sensor 100 can be welded to the protective pipe 120 once they pass the non-conductive/conductive pipe transition sections 112 and 114. The flanges connect the density sensor 100 to the pipeline. Joints of the density sensor 100 can have waterproof sealing.

An electric box 130 is interconnected to the capacitor by wiring. A thermostat 140 and a pressure sensor 150 are mounted to the first transition section 110 and are interconnected to the electric box 130 by wiring. The electric box 130 provides direct current (DC) power to the capacitor, the thermostat 140 and the pressure sensor 150. The thermostat 140 detects the temperature of the multiphase flow passing through the density sensor 100, and the pressure sensor 150 detects the pressure of the multiphase flow passing through the density sensor 100. Data obtained by the density sensor 100 is provided to the data center 40.

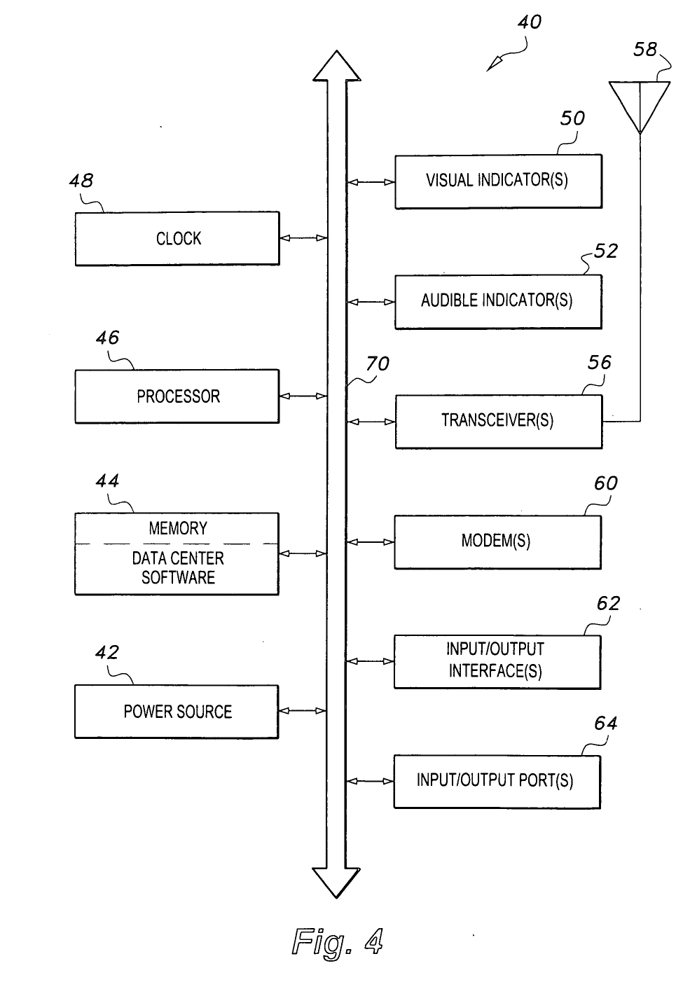

The data center 40 includes a power source 42, a memory 44 that stores data center software, a processor 46, a clock 48, one or more visual indicators 50, one or more audible indicators 52, one or more transceivers 56, one or more modems 60, one or more input/output interfaces 62, and one or more input/output ports 64 (see FIG. 4). These components are communicatively interconnected by a communication bus 70.

The power source 42 is preferably provided from an external power source, such as alternating current (AC) utility power, through use of a power cord, power adapter, etc. However, the power source 42 may also be one or more rechargeable and/or non-rechargeable batteries mounted in the data center 40 to provide power and/or to provide a backup to external power during power outages or the like. The memory 44 carries data center software. The memory 44 can be configured as read only memory (ROM) and/or random access memory (RAM). In general, ROM is used to contain instructions and programs, while RAM is employed for operating and working data. The memory 44 can be removable or non-removable by the user. The memory 44 and processor 46 work together to receive and process signals from the components of the multiphase flow meter and data system 10. The processor 46 is configured as a microcontroller, control logic, firmware, or other circuitry.

The clock 48 serves as a timing mechanism to provide timing data corresponding to particular occurrences associated with the multiphase flow meter and data system 10. The clock 48 can also be used to provide, track, and/or recall the time and date predetermined or preset by the operator. Any predetermined or preset time or date can be used as a default setting to default the clock 48 back after providing timing data for a particular multiphase flow meter and data system 10 occurrence.

The visual indicator(s) 50, if included, is configured to provide a visual indication of a desired data center 40 operating condition. Such a visual indicator(s) 50 can emit light to provide the visual indication and can be a light emitting diode (LED) of any desired color, but may be any type of light.

The audible indicator(s) 52, if included, can be a speaker that is powered by an amplifier to emit any distinctive audible sound, such as a buzzer, chirp, chime, or the like. Alternatively, the audible indicator(s) 52 can be a speaker that relays audible communication information, such as a recorded message, a relayed communication message, or the like. The modem(s) 60 and input/output port(s) 64 can be of conventional types well known in the art.

The transceiver(s) 56 can be of a type well known in the art, and is preferably constructed of miniaturized solid state components so that the transceiver(s) 56 can be removably received in the data center 40. The transceiver(s) 56 can establish a two-way wireless communication link between the data center 40 and a remote device by way of the antenna 58. The modem(s) 60 can be any type of modem.

The input/output interface(s) 62, if provided, can be configured in the form of a button, key, or the like, so that a user may touch, hit, or otherwise engage the input/output interface(s) 62 to cause a signal to be provided to the processor 46.

The input/output port(s) 64 can transfer data in both directions so that updated data center instructions or commands can be set by the user. The transceiver(s) 56 and/or the input/output port(s) 64 can use such communication technologies as cables, fiber optics, radio frequency, infrared communication technology, or the like. A plurality of input/output port(s) 64 can be provided to support multiple communication protocols or methods, or may include a universal port capable of transmitting data in several different modes. Stored data can be downloaded to, or new data center program instructions and data can be uploaded from, a computer, a communication station, or the like.

The data center software carried on the memory 44 of the data center 40 includes a plurality of computer executable instructions. The data center software causes the data center 40 to receive data parameters from the volumetric flow meter 20, the water percentage meter 30 and the density sensor 100, as well as other operational data parameters from the multiphase flow meter and data center 10. The data center software also causes the data center 40 to process the received data parameters and determine various data center results.

The memory 44 of the data center is initially provided with a plurality of density charts that are generated according to well data provided by the operator for a particular well. The data center software uses a plurality of algorithms to calculate and produce density charts with various percentages of oil, gas, and water values from zero percent to one hundred percent using these parameters. The algorithms include:
Wm=Wo+Wg+Ww (1);
Vm*δm=Vo*δo+Vg*δg+Vw*δw (2);
δm=Vo/Vm*δo+Vg/Vm*δg+Vw/Vm*δw (3); and,
δm=% o*δo+% g*δg+% w*δw (4).

The parameters correspond to the total weight of the multiphase flow (Wm), the weight of the crude oil phase (Wo), the weight of the gas phase (Wg), the weight of the water phase (Ww), the total volume of the multiphase flow (Vm), the volume of the crude oil phase (Vo), the volume of the gas phase (Vg), the volume of the water phase (Vw), the percentage (by volume) of the crude oil phase (% o), the percentage (by volume) of the gas phase (% g), the percentage (by volume) of the water phase (% w), the density of the multiphase flow (δm), the density of the crude oil phase (δo), the density of the gas phase (δg), and the density of the water phase (δw).

The operator of the multiphase flow meter and data system 10 provides phase density data with a predetermined accuracy for a particular well. For example, the operator may provide the following well data for a particular well: 0.8987 gr/cm³ for oil, 1.0049 gr/cm³ for water, and 0.0007 gr/cm³ for gas. Table 1 represents part of a density chart that would be calculated and loaded in the data center for a maximum of 80% in the pipeline.

TABLE 1

As 20%

| WELL DATA | 0.8987 | 1.0049 | 0.0007 | |
|---|---|---|---|---|
| gr/cm³ density | OIL % | H₂O % | GAS % | % |
| 0.00736483 | 80 | 0 | 20 | 100 |
| 0.00735783 | 80 | 1 | 19 | 100 |
| 0.00735083 | 80 | 2 | 18 | 100 |
| 0.00734383 | 80 | 3 | 17 | 100 |
| 0.00733683 | 80 | 4 | 16 | 100 |
| 0.00732983 | 80 | 5 | 15 | 100 |
| 0.00732283 | 80 | 6 | 14 | 100 |
| 0.00731583 | 80 | 7 | 13 | 100 |
| 0.00730883 | 80 | 8 | 12 | 100 |
| 0.00730183 | 80 | 9 | 11 | 100 |
| 0.00729483 | 80 | 10 | 10 | 100 |
| 0.00728783 | 80 | 11 | 9 | 100 |
| 0.00728152 | 79 | 0 | 21 | 100 |

The data center 40 calculates the density of the multiphase flow passing through the density sensor 100 based on the dielectric properties of the capacitor of the density sensor 100, makes any adjustment in the density calculation required by the temperature and pressure measurements from the sensors 140 and 150 by reference to temperature and pressure curves stored in memory 44, and determines the possible phase combinations of water, gas, and oil that concur with the density measurement by reference to the precalculated charts stored in memory 44. The number of significant digits in the stored density charts ensures and the degree of precision afforded by the multiphase density sensor 100 ensure that only one combination of multiphase percentage values corresponds to the sensor's density reading. The data center software matches the combination or combinations of percentage of each phase in the density tables stored in the memory 44 of the data center 40.

The density of the multiphase flow passing through the density sensor 100 is directly proportional to the electric measurements of the capacitor, e.g., capacitance, inductance, and/or dielectric frequency. Based on these measurements, the density is calculated instantly according to the measurements of temperature and pressure received, respectively, from the thermostat 140 and pressure sensor 150 from the same period.

For example, capacitance is directly proportional to the dielectric constant, which is proportional to the phase composition of the multiphase fluid flow through the multiphase density sensor 100. Consequently, the capacitance, either instantaneous or average, of the multiphase density sensor can be measured by a capacitance meter. The measured capacitance may be correlated with the density of the multiphase fluid either by correlation with empirically derived charts stored in memory 44 and extrapolation therefrom, or by computation from algorithms well known to those skilled in the art. It will be obvious to those skilled in the art that the density of the multiphase fluid flow may be computed by a processor circuit, digital signal processor, or application specific integrated circuit (ASIC) integral with multiphase density sensor 100 and housed in electric box 130, for example, so that the density is precomputed and input directly to data center 40, or the sensor 100 may measure an immediate parameter, e.g., voltage on the conductive plates, which is input to the data center 40 for computation of the capacitance and density of the multiphase fluid.

The data center 40 also calculates the multiphase percentages when the densities of each phase are unknown by taking the water percentage from a water percentage meter mounted next to the density sensor 100. With the water percentage, the data center 40 calculates the gas and oil percentages based on the generated density charts of possible phase combinations according to the multiphase density measurement by the density sensor 100. The margin of error in the generated density charts is given by their small increases in the percentages of possible phase combinations, which can be modified according to the accuracy of the field data.

The multiphase flow meter and data system 10 provides assessed value measurements in dual-phase pipelines (crude oil with the presence of water, or gas with the presence of condensed oil or water) by determining the water percentage in crude oil or gas, or the condensed oil percentage in gas by only modifying data with the data center software.

The multiphase flow meter and data system 10 provides a way to measure the percentages of water, gas, and/or crude oil that flow in a pipeline without the separation of phases on-line and in real time. Traditional equipment, such as gas phase separators and measuring tanks for liquid phases, are not needed when using the multiphase flow meter and data system 10. The multiphase flow meter and data system 10 has numerous advantages over traditional measuring. For example, the multiphase flow meter and data system 10 allows reliable real-time measurement with the possibility to transmit results to a remote location without the presence of a technician at the measuring site.

The multiphase flow meter and data system 10 allows the battery equipment of the wells to become automated with a rotating well measurement system through remote automatic valves (actuators). The multiphase flow meter and data system 10 has a memory archive of numerous months production per well and/or battery. The multiphase flow meter and data system 10 allows a new and simplified design of oilfields without gas separation at the batteries and the duplication of gas and liquid pipelines. The multiphase flow meter and data system 10 can be combined with multiphase pumps (available on the market) to allow the multiphase flow to reach unified offsite gas treatment and oil dehydration plants.

The multiphase flow meter and data system 10 provides cost reduction by removing the traditional gas separators and liquid meters. The multiphase flow meter and data system 10 prevents accidental measuring tank spills. The multiphase flow meter and data system 10 eliminates the possibility of contaminating the water supply and/or other ecological disasters caused by oil spills. The multiphase flow meter and data system 10 reads the temperature and pressure of the multiphase flow and automatically corrects the multiphase density and the density of each phase.

It is to be understood that the present invention is not limited to the embodiments described above, but encompasses any and all embodiments within the scope of the following claims.

I claim:

1. A multiphase flow meter and data system, comprising:
a volumetric flow meter;
a water percentage meter;
a multiphase density sensor; and
a data center interconnected to the volumetric flow meter, the water percentage meter, and the multiphase density sensor, the data center having:
means for receiving data measurements of parameters of a multiphase fluid flow from the volumetric flow meter, the water percentage meter, and the multiphase density sensor prior to separation of phases in the fluid flow; and
means for determining the volume percentage of each phase in the multiphase fluid from the data measurements.

2. The multiphase flow meter and data system according to claim 1, wherein the multiphase density sensor comprises piping having a first transition section, an electrically non-conductive section, and a second transition section, the piping being adapted for flow of the multiphase fluid therethrough.

3. The multiphase flow meter and data system according to claim 2, further comprising two conductive plates externally mounted to the non-conductive section, the non-conductive section being between the two plates, thereby forming a capacitor.

4. The multiphase flow meter and data system according to claim 3, wherein said multiphase density sensor further comprises a protective pipe, the protective pipe covering said non-conductive section, at least a portion of said first transition section, and at least a portion of said second transition section.

5. The multiphase flow meter and data system according to claim 4, wherein said protective pipe forms a Faraday cup.

6. The multiphase flow meter and data system according to claim 1, further comprising a temperature sensor connected to said multiphase density sensor for measuring the temperature of the multiphase flow passing through said multiphase density sensor.

7. The multiphase flow meter and data system according to claim 6, further comprising a pressure sensor connected to said multiphase density sensor for measuring the-pressure of said multiphase flow passing through said multiphase density sensor.

8. The multiphase flow meter and data system according to claim 1, wherein said data center comprises:
a processor; and,
memory connected to the processor.

9. The multiphase flow meter and data system according to claim 8, wherein said data center further comprises a clock connected to the processor.

10. The multiphase flow meter and data system according to claim 8, wherein said data center further comprises at least one visual indicator connected to the processor.

11. The multiphase flow meter and data system according to claim 8, wherein said data center further comprises at least audible indicator connected to the processor.

12. The multiphase flow meter and data system according to claim 8, wherein said data center further comprises a transceiver connected to the processor.

13. The multiphase flow meter and data system according to claim 12, wherein said transceiver is a wireless transceiver, said multiphase flow meter and data system further comprising an antenna connected to the wireless transceiver.

14. The multiphase flow meter and data system according to claim 8, wherein said data center further comprises at least one modem connected to said processor.

15. The multiphase flow meter and data system according to claim 8, wherein said data center further comprises a user interface connected to said processor.

16. A multiphase flow meter and data system, comprising:
a sensor pipe adapted for insertion into a conduit carrying a multiphase fluid flow, the pipe having first and second transition sections adapted for attachment to the conduit and an electrically non-conductive transition section disposed between the first and second transition sections;
a pair of electrically conductive plates disposed on diametrically opposite sides of the electrically non-conductive section of the sensor pipe, whereby the conductive plates and the electrically non-conductive section have a capacitance proportional to the phase composition of the multiphase fluid flowing in the sensor pipe;
a power source connected to the electrically conductive plates for applying a voltage thereto;
a sensor connected to the electrically conductive plates, the sensor producing an electrical signal proportional to the capacitance of the sensor pipe and electrically conductive plates when the multiphase fluid flows through the sensor pipe and the voltage is applied to the plates by the power source;
means for computing the aggregate density of the multiphase fluid from the electrical signal produced by the sensor; and
a data center connected to,the sensor, the data center having means for determining the percentage composition of each phase of the multiphase fluid from the aggregate density of the multiphase fluid.

17. The multiphase flow meter and data system according to claim 16, wherein said data center further comprises means for receiving density measurements for each phase of the multiphase fluid, said means for determining the percentage composition comprising:
a processor;
a memory connected to the processor;
a plurality of charts stored in the memory, the charts containing calculated tables relating the aggregate density of the multiphase fluid to the percentage composition of each phase in the multiphase fluid, given the density of each phase in the multiphase fluid;
means executable by the processor for comparing the aggregate density computed from the signal output by the sensor and the densities of each phase supplied by the means for receiving to the charts to determine the percentage composition of each phase; and
means for outputting the percentage composition of each phase of the multiphase fluid to an output device.

18. The multiphase flow meter and data system according to claim 16, further comprising a water percentage meter attached to the sensor pipe having means for measuring the percentage of water in the multiphase fluid and sending a corresponding signal to the data center, said data center further comprising means for receiving the signal from the water percentage meter, said means for determining the percentage composition comprising:
a processor;
a memory connected to the processor;
a plurality of charts stored in the memory, the charts containing calculated tables relating the aggregate density of the multiphase fluid to the percentage composition of each phase in the multiphase fluid given the percentage of water in the multiphase fluid;
means executable by the processor for comparing the aggregate density computed from the signal output by the sensor and the water percentage from the water percentage meter signal to the charts to determine the percentage composition of each phase other than water in the multiphase fluid; and
means for outputting the percentage composition of each phase of the multiphase fluid to an output device.

19. The multiphase flow meter and data system according to claim 16, further comprising a volumetric flow meter connected to the sensor pipe for measuring the volumetric flow of the multiphase fluid.

20. A method of determining percentage composition of a plurality of phases in a multiphase fluid flow through a conduit, comprising the steps of:
installing a section of non-conductive pipe in the conduit;
attaching opposing conductive plates to the section of non-conductive pipe to form a meter section;
measuring the capacitance of the meter section when the multiphase fluid is flowing through the conduit;
determining the aggregate density of the multiphase fluid from the measured capacitance;
calculating the percentage composition of each phase of the multiphase fluid from the aggregate density of the multiphase fluid and the density of each phase when the density of each phase is known; and
measuring the percentage of water in the multiphase fluid and calculating the percentage of each phase of the multiphase fluid from the aggregate density of the multiphase fluid and the percentage water composition when the density of each phase is not known.
